(19) United States
(12) Patent Application Publication
(10) Pub. No.: US 2024/0262276 A1
(43) Pub. Date: Aug. 8, 2024

(54) COMBINATION MOBILE FITNESS CENTER AND MARTIAL ARTS DOJO

(71) Applicant: Ernesto Fuentes, San Antonio, FL (US)

(72) Inventor: Ernesto Fuentes, San Antonio, FL (US)

(21) Appl. No.: 18/624,694

(22) Filed: Apr. 2, 2024

Related U.S. Application Data
(60) Provisional application No. 63/442,900, filed on Feb. 2, 2023.

(51) Int. Cl. B60P 3/025; A63B 71/06; B60K 35/22; B60R 1/29

(52) U.S. Cl. CPC B60P 3/025; A63B 71/0622; B60K 35/22; B60R 1/29; A63B 2071/0638

(57) ABSTRACT

A combination mobile fitness center and martial arts dojo is provided. The combination mobile fitness center and mobile martial arts dojo is housed in a functional land vehicle having an open floorplan along which at least six training stations are spaced apart. Each training station provides a swivel top pad and a first side pad, a second side pad, and a swivel side pad, wherein all the pads are operatively associated with a center pad. A camera capturing images of at least six training stations broadcasts the captured images on a display screen along an exterior of the vehicle so that guardians of the users of the training stations can be monitored.

### CROSS-REFERENCE TO RELATED APPLICATION

This application claims the benefit of priority of U.S. provisional application number 63/442,900, U.S. provisional application number filed Feb. 2, 2023, the contents of which are herein incorporated by reference.

### BACKGROUND OF THE INVENTION

The present invention relates to fitness systems and, more particularly, to a mobile fitness center to empower youth to get physically active.

The benefits of physical activity for children are varied and far-reaching. Participating in physical activities not only gets kids moving after sitting all day (in class or in front of video screens) but can set them up for success for the rest of their lives. Kids who get regular physical activity enjoy better cardiorespiratory and cardiovascular health, greater bone density, stronger muscles, and a healthier body mass. Regular physical activity also reduces the risks of chronic health problems. And so, children who are physically active reduce their risk of becoming obese and developing heart disease, stroke, diabetes, and various cancers. Furthermore, regular physical activity means that they are also more likely to enjoy low healthcare costs over the course of their lives. Moreover, physical activity typically results in enjoying a healthier body image and greater self-esteem. Being physically fit can also go a long way toward helping kids and teens view themselves as strong, capable individuals, and as they get older, fitness can also help teens to feel more confident in both their abilities and their appearance. Regular physical activity also improves mind-body coordination.

Unfortunately, parents' schedules are full and prevent them from taking the conventionally necessary steps, that kids themselves cannot, to facilitate their child's participation in regular physical activity—i.e., transporting their child from home or school to the location that the organized physical activity is being conducted.

As can be seen, there is a need for a mobile fitness center to empower youth to get physically active and participate in martial arts by, in effect, bringing the dojo to the participants.

### SUMMARY OF THE INVENTION

The present invention embodies a mobile fitness center configured to serve as a resource for providing physical activity to participants in the form of structured activities with trained instructors and organized events, including but not limited to daycare centers, kindergartens, birthday parties, social gatherings, local carnivals, and any other social, public and/or private activity.

The mobile fitness center is configurable as a mobile martial arts dojo for instructing participants in the skills and values of martial arts techniques, including discipline, self-esteem, athletic-conditioning and most importantly self-defense.

The mobile fitness center can travel to daycares, schools, corporate events, festivals, birthday parties, social events, malls, private or governmental events, and any other public or private occasion, so children can benefit from physical activity which is so important to their mental and physical development, without parents having to chauffeur their kids to be part of activities, which are typically contained in distant store-front locations adjacent busy thoroughfares. In one embodiment of the present invention, the mobile martial arts dojo can introduce martial arts techniques to the driveway of a participant's house or in a parking lot of nearby community center or school.

In one aspect of the present invention, mobile fitness center provides the following: at least six training stations spaced apart along one or more interior walls of a land vehicle, wherein each training station provides a swivel top pad and a first side pad, a second side pad, and a swivel side pad, wherein all said pads are adjacent to a center pad; a camera capturing images of the at least six training stations; and a display screen along an exterior of the land vehicle, wherein the display screen displays the captured images of the camera.

In another aspect of the present invention the mobile fitness center provides the following: at least six training stations spaced apart along an interior wall of a land vehicle; each training station provides a swivel top pad and a first side pad, a second side pad, and a swivel side pad, wherein said side and top pads are adjacent to a center pad; a camera capturing images of the at least six training stations; and one or more display screens along an exterior of the land vehicle, wherein the one or more display screens display the captured images of the camera, wherein the land vehicle has an elongated floorspace having a square footage of at least three hundred square feet, wherein the first and second side pads are disposed adjacent to a first longitudinal edge of the center pad, and wherein the swivel side pad is disposed adjacent to a second longitudinal edge of the center pad, wherein the swivel side pad is configured to pivot approximately one-hundred and eighty degrees along a first axis of rotation relative to the interior wall, wherein the swivel top pad is configured to pivot approximately one-hundred and eighty degrees along a second axis of rotation relative to the interior wall, wherein the first and second axis are substantially orthogonal relative to each other, and further providing the following: for each training station, a teaching screen attached adjacent thereto; an indicia area disposed along an exterior of the land vehicle adjacent to the one or more display screens, whereby a portion of the indicia area is visible to an observer of one of the one or more display screens, wherein the indicia area circumscribes the one or more display screens, wherein each teaching screen is configured to broadcast one or more fitness instructions, and wherein the one or more fitness instructions related to martial arts.

These and other features, aspects, and advantages of the inventions become better understood with reference to the drawings, description and claims.

### BRIEF DESCRIPTION OF THE DRAWINGS

FIG. 1 is a schematic section view of an exemplary embodiment of the present invention.

FIG. 2 is a detailed view of an arrangement of pads of an exemplary training station of an exemplary embodiment of the present invention.

FIG. 3 is an exterior schematic view of an exemplary embodiment of the present invention.

FIG. 4 is a flow chart of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

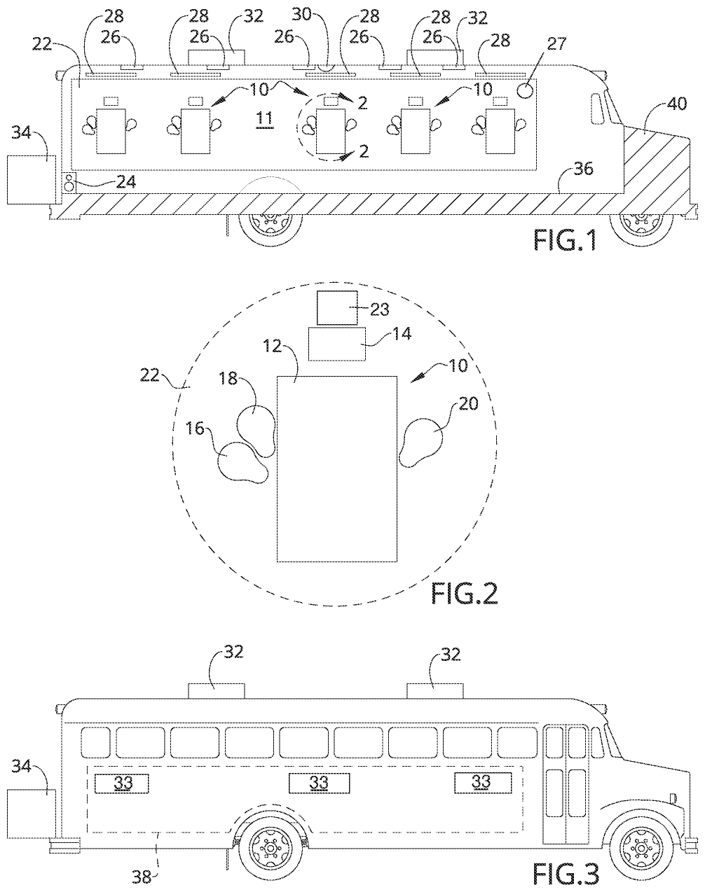

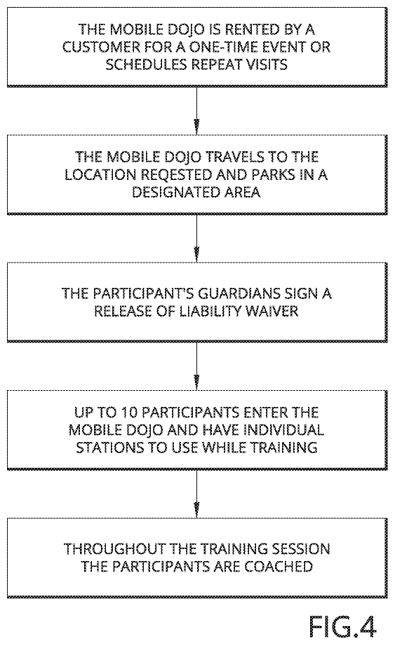

Referring to FIGS. 1 through 4, the present invention may provide a mobile fitness center embodied in a vehicle 40 having a minimum interior footprint or floor square footage of three hundred square feet. For instance, a 75 passenger Bluebird™ school-bus with the passenger seats removed may suffice.

Along this open floor space, the present invention provides a plurality of training stations 10. In some embodiments, the training stations 10 may be connected to one or more interior walls 11 by way of a backboard 22. Each training station 10 may include a center pad 12. Pivotably attached along an upper surface of the center pad 12 or the supportive backboard 22 may be a swivel top pad 14. Resiliently attached along both longitudinal sides of the center pad 12 may be a first side pad 16, a second side pad 18 and a swiveling side pad 20, respectively. The first and second side pads 16 and 18 are configurable as punching and kicking targets. The swiveling side pad 20 may be adapted to be height and angle adjustable for different training purposes. Each training station 10 may have a display screen 23 located adjacent the center pad 12 to facilitate instructions by broadcasting instructive videos so that a user of the training station 10 may view the broadcast while applying the skills taught in the video to the pads 12, 14, 16, and 18.

Along floor 36 of the vehicle 40 may be at least one speaker 24 so that trainers' instructions are broadcast within the interior space. Likewise, the interior space may provide a sound-system, a microphone system, and an indoor surveillance camera 27. The interior space may provide ceiling lights 26, station lights 28, and a center light 30. Each station lights 28 may be disposed suprajacent each training station 10. Some of the lights 26, 28, and 30 may be strobe lights.

An air conditioner unit 32 for the vehicle 40 may be provided to regulate the temperature of the interior space. The air conditioner unit 32 may include a custom-made electric generator metal base mount. A generator 34 may be provided, preferably, along the outside of the vehicle 40 to energize the lights 28, 30 and air conditioner unit 32.

The interior space may also provide hardwood panels, wood-grain floor panels, wood trim, fire extinguishers, finishing nails, wood varnish, and wood cabinets.

The external surface of the vehicle 40 may provide an exterior advertising area 38, where decals, logos, stickers, and other signals or messages may be provided or displayed. In one embodiment, the vehicle 40 is configured as a mobile dojo with karate-figure decals and vinyl logo stickers adhered to metal circles centered on each side of the vehicle 40.

In one embodiment, the electric generator may be mounted on a custom- made electric generator metal base mount which is installed in the rear exterior of vehicle 40. The vehicle 40 provides roof-top air-conditioning units (7,000 BTU) and is connected to the electric generator. A back-up camera may be installed on the rear of vehicle 40. Flatscreen display monitors 43 may be installed on the exterior of the vehicle 40.

Along the interior space, along the interior walls 11, hardwood panels may be installed using finishing nails to provide an advantageous interior of the vehicle 40. Wood trim may be used to frame the interior walls 11. The interior walls 11 and trim are coated with wood varnish. The swivel blocking targets, punching targets, kicking targets may be installed on the hardwood panels. Florescent light fixtures may be installed on the interior ceiling of vehicle 40. A 750-watt sound system may be installed in the wood cabinet at front of vehicle 40. A wireless professional microphone system may be connected to the 750-watt sound system. Surveillance cameras are connected to the electric generator. Wood-grain floor panels may also be installed on floor 36 of vehicle 40. Fire extinguishers are provided at the front and rear of vehicle 40.

The logos and decals are used to advertise and identify the brand. The air-conditioning is used to cool the interior during intense physical activity. The 13,000-wattselectric generator is used to power the air-conditioning units 32, the inside lighting, 750-watt sound system, the indoor surveillance cameras, and the flat-screen display monitors 23. The wood panels absorb impact and protect the 20 windows. The panels create the surface for the swivel blocking targets 20, the punching targets 18 and the kicking targets 16 to be mounted. Swivel blocking targets 20, the punching targets 18 and the kicking targets 16 are utilized to perform the sequences of martial arts drills. The back-up camera is utilized for safety vehicle backing. The flat-screen display monitors 23 will be used inside to display safety and conduct instructions, while the display monitors 33 along the exterior of the vehicle are for parents and adults to observe the activities taking place inside vehicle 40 via surveillance camera. The sound-system, which may be installed in the wood cabinet, may be bolted to the inside vehicle floor 36. The sound system will be used to project the instructor's voice and play motivational music throughout the interior space and may be aided by a wireless professional microphone system. Floor panels may be for traditional decoration. With the mobility of the vehicle 40, traditional decoration, and the training stations 10, each with three targets the present invention embodies a mobile dojo where children will interact and participate in physical activity, in a fun and safe environment, while are learning martial arts moves of self-defense.

The interior space of the bus may be equally divided into participant training stations 10; in some embodiments, five down each side. Once the hardwood panels are securely attached to the interior sides of the vehicle 40, they serve as walls, protection for the vehicular windows, insulation to aid the air conditioning units with efficiency and to absorb the impact of the participants' movements. Each participant's station is equipped with a specialized set of striking targets that are attached to the wood panel walls or center pad 12 and diagrammed in a specific way that allows the participant to perform a series of defensive motions to the left, the right and to perform a combination of punches and kicks, using both left and right extremities. Each routine is carefully planned in accordance with each striking device to achieve maximum learning of the art of karate within the space of each participant's training station 10. Starting with guidance about safety and etiquette, followed by warm up, the core of the program, designed by an internationally certified martial arts instructor, is provided through a sequences or routine integrated for different skill levels. The routines are developed with an unmatched understanding of bio-mechanical functionality of the participants, proper pedagogy to motivate and keep the attention of the participants for the required period and incorporate the correct techniques to have the best utilization of the space and equipment.

The mobile fitness center can be rented for a one-time event or scheduled for repeat visits to a location of your choice. Participant's guardians will have to sign a release of liability waiver. Up to ten children can utilize the then individual training stations 10 inside the mobile martial arts/dojo at a time, typically for 30-minute sessions. Once assigned to a training station 10, participants will be informed of rules for safety and conduct. After some initial warm-up stretches, the participants will be guided in unison through a combination of defensive and proper martial art strike techniques. Throughout the session participants will be coached on the importance of self-control and environmental awareness, while gaining a sense of empowerment from strengthening their bodies through intensive physical activity. Participants enrolled in repeat visit locations will advance through several levels of the martial arts disciplines.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A combination mobile fitness center and martial arts dojo comprising:
at least six training stations spaced apart along an interior wall of a land vehicle;
each training station provides a swivel top pad and a first side pad, a second side pad, and a swivel side pad, wherein said side and top pads are adjacent to a center pad;
a camera capturing images of the at least six training stations; and
one or more display screens along an exterior of the land vehicle, wherein the one or more display screens display the captured images of the camera.

2. The combination mobile fitness center and martial arts dojo of claim 1, wherein the land vehicle has an elongated floorspace having a square footage of at least three hundred square feet.

3. The combination mobile fitness center and martial arts dojo of claim 1, wherein the first and second side pads are disposed adjacent to a first longitudinal edge of the center pad, and wherein the swivel side pad is disposed adjacent to a second longitudinal edge of the center pad.

4. The combination mobile fitness center and martial arts dojo of claim 3, wherein the swivel side pad is configured to pivot approximately one-hundred and eighty degrees along a first axis of rotation relative to the interior wall.

5. The combination mobile fitness center and martial arts dojo of claim 4, wherein the swivel top pad is configured to pivot approximately one-hundred and eighty degrees along a second axis of rotation relative to the interior wall, wherein the first and second axis are substantially orthogonal relative to each other.

6. The combination mobile fitness center and martial arts dojo of claim 5, further comprising, for each training station, a teaching screen attached adjacent thereto.

7. The combination mobile fitness center and martial arts dojo of claim 6, further comprising an indicia area disposed along an exterior of the land vehicle adjacent to the one or more display screens, whereby a portion of the indicia area is visible to an observer of one of the one or more display screens.

8. The combination mobile fitness center and martial arts dojo of claim 7, wherein the indicia area circumscribes the one or more display screens.

9. The combination mobile fitness center and martial arts dojo of claim 8, wherein each teaching screen is configured to broadcast one or more fitness instructions.

10. The combination mobile fitness center and martial arts dojo of claim 9, wherein the one or more fitness instructions are related to martial arts.
